(19) United States
(12) Patent Application Publication
(10) Pub. No.: US 2021/0163264 A1
(43) Pub. Date: Jun. 3, 2021

(54) ELEVATOR GUIDING DEVICE AND ELEVATOR SYSTEM COMPRISING THE SAME

(71) Applicant: Otis Elevator Company, Farmington, CT (US)

(72) Inventor: Jeff Cheng, Shanghai (CN)

(21) Appl. No.: 17/103,148

(22) Filed: Nov. 24, 2020

(30) Foreign Application Priority Data
Nov. 29, 2019 (CN) 201922103765.9

(51) Int. Cl. B66B 11/02; B66B 7/04

(52) U.S. Cl. CPC B66B 11/0273; B66B 7/046

(57) ABSTRACT

An elevator guiding device and an elevator system including the elevator guiding device. The elevator guiding device is configured to be installed on an elevator car and includes a biased member and a guiding and contacting member. The guiding and contacting member is connected to the biased member and is arranged to contact an elevator guiding rail when the elevator car is running in an unbalanced loaded state along the elevator guiding rail and cause the biased member to be biased, for guiding a running trajectory of the elevator car. The elevator guiding device further includes a connection member connected to the biased member and having an elastic member and a stop member, the elastic member is arranged to provide a pre-tightening force between the biased member and the connection member and provide a resistance force when the biased member is biased.

### FOREIGN PRIORITY

This application claims priority to Chinese Patent Application No. 201922103765.9, filed Nov. 29, 2019, and all the benefits accruing therefrom under 35 U.S.C. § 119, the contents of which in its entirety are herein incorporated by reference.

### TECHNICAL FIELD OF INVENTION

The utility model relates to the technical field of elevators, and particularly to an elevator guiding device and an elevator system comprising the elevator guiding device.

### BACKGROUND OF THE INVENTION

Elevators have received wide application in modern society and can bring great convenience to people's work and daily life. Although various types of elevator devices, apparatuses or systems have already been provided in the prior art to meet people's various different application needs, these existing elevator products still have some drawbacks and shortcomings in aspects such as structural configuration, installation and use, work performance, manufacturing cost, safety and reliability. For example, for existing elevator guiding devices that provide guidance for elevator cars, further structural improvements and optimizations can be made.

### SUMMARY OF THE INVENTION

In view of the foregoing, the utility model provides an elevator guiding device and an elevator system including the elevator guiding device, so as to resolve or at least alleviate one or more of the problems described above as well as problems of other aspects existing in the prior art.

Firstly, according to a first aspect of the utility model, an elevator guiding device is provided, which is configured to be installed on an elevator car and includes: a biased member; and a guiding and contacting member connected to the biased member and arranged to contact an elevator guiding rail when the elevator car is running in an unbalanced loaded state along the elevator guiding rail and cause the biased member to be biased, for guiding a running trajectory of the elevator car; wherein the elevator guiding device further comprises a connection member connected to the biased member and having an elastic member and a stop member, the elastic member is arranged to provide a pre-tightening force between the biased member and the connection member and provide a resistance force when the biased member is biased, and the stop member is arranged to stop the biased member when the biased member is biased to a preset position.

In the elevator guiding device according to the utility model, optionally, the elastic member and the stop member are a spring and an annular sleeve sleeved over the connection member respectively, and the end of the annular sleeve facing the biasing part is spaced apart from the biased member by a preset distance.

In the elevator guiding device according to the utility model, optionally, the spring is a coil spring, and an outer diameter of the annular sleeve is smaller than an inner diameter of the coil spring.

In the elevator guiding device according to the utility model, optionally, the stop member is a protrusion provided along a circumferential direction on at least a part of an outer surface of the connection member, and the protrusion is configured not to interfere with the elastic member and the end of the protrusion facing the biased member is spaced apart from the biased member by a preset distance.

In the elevator guiding device according to the utility model, optionally, the connection member is a bolt with a nut installed at an end, and the respective ends of the elastic member and the stop member facing the nut both abut against the nut.

In the elevator guiding device according to the utility model, optionally, the biased member is installed on the top, side and/or bottom of the elevator car.

In the elevator guiding device according to the utility model, optionally, the elevator guiding device further includes a bracket installed on the top, side and/or bottom of the elevator car, and the biased member is installed on the bracket.

In the elevator guiding device according to the utility model, optionally, the connection member and the elastic member are made of a metal material, and the stop member is made of an elastic material.

In the elevator guiding device according to the utility model, optionally, the biased member has a first end, and a second end fixed relative to the elevator car, the guiding and contacting member is a roller rotatably installed on the biased member and located between the first end and the second end, the biased member is arranged to be pivotable around a fixed point of the second end on the elevator car after the roller contacts the elevator guiding rail, and the connection member is installed at the first end of the biased member.

In addition, according to a second aspect of the utility model, an elevator system is also provided, which includes: an elevator guiding rail; an elevator car running along the elevator guiding rail; and one or more elevator guiding devices as described in any one of the above, which are installed on the elevator car.

From the following detailed description combined with the accompanying drawings, the principles, features, characteristics and advantages of various technical solutions according to the utility model will be clearly understood. For example, the elevator guiding device according to the utility model has a compact structure and is easy to install, manufacture and maintain. The use of the utility model can effectively reduce the number of components in the elevator guiding device, optimize spatial layout of the system, and reduce product costs, while providing good work performance and providing sufficient guarantee for the safe and reliable operation of the elevator.

### BRIEF DESCRIPTION OF THE DRAWINGS

The technical solutions of the utility model will be described in further detail below with reference to the accompanying drawings and embodiments. However, it should be understood that these drawings are designed merely for the purpose of explanation and only intended to conceptually illustrate the structural configurations described herein, and are not required to be drawn to scale.

FIG. 1 is a schematic structural view showing components of an embodiment of an elevator guiding device according to the utility model.

FIG. 2 is a schematic view showing a working model of an elastic member in the embodiment of the elevator guiding device shown in FIG. 1.

### DETAILED DESCRIPTION OF THE INVENTION

First, it should be noted that the structural components, arrangements, characteristics, advantages and the like of the elevator guiding device and the elevator system comprising the elevator guiding device according to the utility model will be described below by way of example. However, all the descriptions should not be understood as limiting the utility model in any way. Herein, the technical term “connect (or connected, etc.)” covers situations where a component is directly connected to another component and/or indirectly connected to another component.

In addition, for any single technical feature described or implied in the embodiments mentioned herein or any single technical feature shown or implied in individual drawings, the utility model still allows for any combination or deletion of these technical features (or equivalents thereof) without any technical obstacle. Therefore, it should be considered that these more embodiments according to the utility model are also within the scope of the description of this document. In addition, for the sake of brevity, general items already known to those skilled in the art will not be repeated herein.

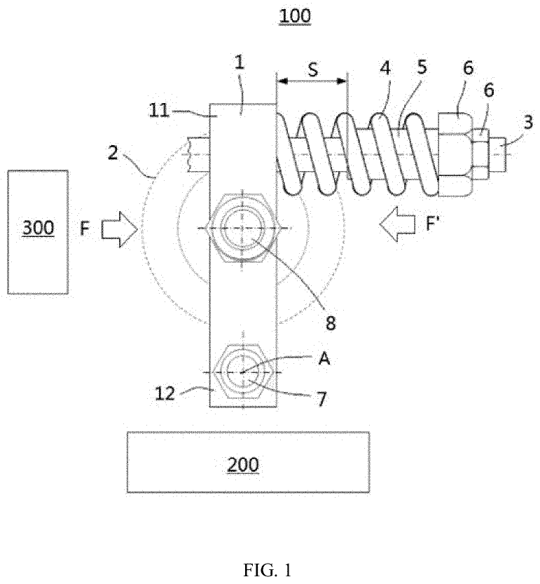

FIG. 1 schematically shows the general composition of an embodiment of an elevator guiding device according to the utility model. The elevator guiding device is configured to be installed on an elevator car so as to guide the elevator car when the elevator car is running in an unbalanced loaded state along an elevator guiding rail, thereby preventing or reducing the occurrence of elevator car swaying, turning over and the like. In the embodiment shown in FIG. 1, the elevator guiding device 100 may include a biased member 1, a guiding and contacting member 2 and a connection member 3, which are realized in structural forms of a pivoting arm, a roller and a bolt respectively. The elevator guiding device 100 is also generally called a “roll guide” in the industry, and the utility model will be described in detail below by means of this example.

Specifically, the biased member 1 is arranged to have a first end 11 and a second end 12. For example, the second end 12 may be fixed to an elevator car 200 by any feasible connection means 7 such as a connection member 7 (such as bolts, screws, pins, etc.), welding and the like. For example, the second end 12 may be fixed to a suitable position such as a crosshead on the top of the elevator car 200, so that the second end 12 of the biased member 1 can be fixed relative to the elevator car 200. In addition, the guiding and contacting member 2 in the form of a roller may be installed between the first end 11 and the second end 12 of the biased member 1. For example, the guiding and contacting member 2 may be installed to the biased member 1 by connection means such as a connection member 8 (such as bolts, screws, pins, etc.), welding and the like.

Reference is made to FIG. 1, in which the elevator car and the elevator guiding rail are represented merely schematically by using blocks 200 and 300 respectively. When the elevator car 200 is running along the elevator guiding rail 300, whether it is empty or currently loaded, it is possible that the total center of mass of the elevator car will deviate from the straight line where an elevator lifting rope is located, so the elevator car will be running in an unbalanced loaded state, which will result in a torque that causes the elevator car to deviate from the normal running trajectory. In this case, the guiding and contacting member 2 installed on the elevator car 200 and in the form of a roller will contact the elevator guiding rail 300, thereby pressing against the elevator guiding rail 300 to prevent the elevator car 200 from turning over, swaying and the like unexpectedly.

As shown in FIG. 1, when the guiding and contacting member 2 presses against the elevator guiding rail 300, the elevator guiding rail 300 will apply a force F to the guiding and contacting member 2, which will drive the biased member 1 to pivot around the fixed point of the second end 12 thereof on the elevator car 200 (that is, swing toward the right side in the figure around the position A shown in FIG. 1), so that an elastic member 4 in the connection member 3 installed on the biased member 1 is compressed accordingly, thereby providing a resistance force F′ in the opposite direction to the above-mentioned force F. Through the synergy between the above two forces F and F′, the unbalanced load adjustment process during the running of the elevator car 200 can be smoother and more stable, and the elevator car 200 can be prevented from swaying violently or even turning over.

With continued reference to FIG. 1, in addition to the above-mentioned elastic member 4, a stop member 5 is also provided on the connection member 3. The stop member 5 can realize a more sufficient and reliable safety protection effect, etc. As compared with the prior art, the elastic member function and the stop member function are integrated into the connection member 3 at the same time. This compact solution can not only provide reliable working performance, but also can make the elevator guiding device better adapt to the limited space in the elevator system (for example, as compared with the prior art, components such as the biased member 1 with a smaller size can be used). Moreover, the number of components that need to be manufactured and assembled in the elevator guiding device can be effectively reduced, thereby helping reduce cost and improve product competitiveness.

As far as the stop member 5 is concerned, as an example, when the elevator car 200 has a relatively serious unbalanced load condition when for example running along the elevator guiding rail 300, a relatively large force F will be generated between the guiding and contacting member 2 of the elevator guiding device 100 and the elevator guiding rail 300 at this point, which will cause the biased member 1 to produce a larger pivoting angle when biased. Once the above-mentioned pivoting angle is too large, it is very easy to cause obvious swaying of the elevator car 200, or even turning over, which will bring very unfavorable safety risks to personal safety, equipment, and property. In this case, through the stop member 5 provided on the connection member 3, the biased member 1 can be stopped once it reaches a preset position, thereby restricting the further movement of the biased member 1, and therefore effectively realizing safety protection and other functions. It can be understood that the above-mentioned preset position may be flexibly set and adjusted according to various different requirements in practical applications, and more descriptions will be given below in conjunction with specific structural examples.

As an example, in an optional situation, the above-mentioned elastic member 4 may be easily realized in many types of spring forms such as coil springs and disc springs. For example, a coil spring that meets actual application requirements can be directly sleeved over the connection member 3 so as to be used as the elastic member 4. After the elastic member 4 has been assembled to the connection member 3, it can provide a pre-tightening force between the biased member 1 and the connection member 3. Generally, the elastic member 4 may be made of any suitable metal material, such as steel, stainless steel, metal alloy and the like, so as to provide working performances that meet specific application requirements, such as sufficient strength, rigidity and/or corrosion resistance.

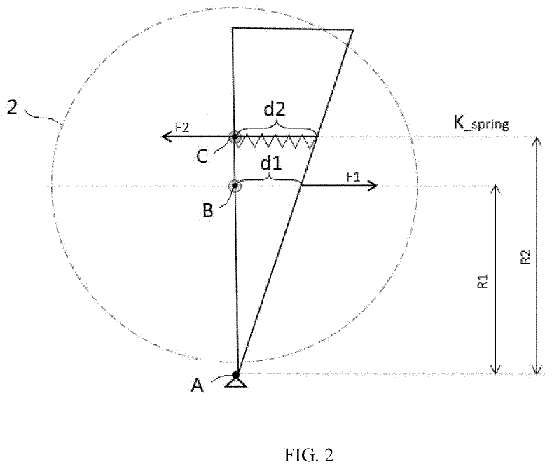

With combined reference to FIGS. 1 and 2, although the connection member 3 having the elastic member 4 is allowed to be installed at any suitable position on the biased member 1 in the utility model, it would be advantageous if the connection member 3 is arranged at the first end 11 or arranged at the position B of the guiding and contacting member 2 on the biased member 1. Specifically, if the elastic member 4 having an own initial stiffness K_spring is arranged at any position C on the biased member 1 (which is at a radius distance R2 from the pivot point A), after the biased member 1 is pivoted by an angle under the action of force, the movement distance of the elastic member 4 at the position point C is d2, and the corresponding force is F2, that is, K_spring=F2/d2; at the same time, the position point B is at a radius distance R1 from the pivot point A, the movement distance of the elastic member 4 at this position B is d1, and the corresponding force is F1; then when the elastic member 4 is arranged at the above position C, the achieved equivalent stiffness K_eq=F1/d1. In this way, the following relation (3) can be obtained from the following relations (1) and (2):

F1=F2*(R1/R1) (1)

d1=d2/(R2/R1) (2)

K_eq=K_spring*(d2/d1)2 (3).

From the above, it can be known that when R2≥R1, the actual equivalent stiffness K_eq of the elastic member 4 will be a multiple of its own initial stiffness K_spring, which means that when the connection member 3 with the elastic member 4 is arranged in the above manner, the stiffness of the elastic member 4 can be effectively amplified, thereby providing a more optimized solution. For example, an elastic member with a relatively small stiffness can be selected under the premise of meeting application requirements, which is more advantageous for promoting the formation of a highly compact spatial layout. Regarding the above very advantageous optional arrangement of the connection member 3 with the elastic member 4, it has been adopted in the embodiment shown in FIG. 1.

In addition, for the above-mentioned stop member 5, it can optionally be in the form of an annular sleeve, which is sleeved over the connection member 3. As shown in FIG. 1, by arranging the annular sleeve such that a preset distance S is maintained between one end of the annular sleeve and the biased member 1, the purpose of enabling the biased member 1 to be stopped at the preset position discussed above can be achieved. In addition, since the elastic member 4 is provided on the connection member 3 together with the stop member 5, in order to avoid interference between them, an outer diameter of the stop member 5 in the form of an annular sleeve may be set to be smaller than an inner diameter of the elastic member 4 in the form of a coil spring. Such a structural design is not only simple and practical, but also enables a very easy installation, manufacturing and maintenance, and can effectively save the overall space occupied. As an optional situation, the stop member 5 can be made of elastic materials such as rubber, polyurethane, etc., which can realize good effects such as mitigating the impact of vibration and reducing weight.

As another example, the stop member 5 is also allowed to be directly arranged on the outer surface of the connection member 3 for example by means of casting, machining, welding and the like in the utility model. For example, a protrusion may be formed on at least a part of the outer surface of the connection member 3 along the circumferential direction thereof, and the function of the stop member 5 described above is realized by such a protrusion. Similarly, the above-mentioned protrusion on the connection member 3 will be configured not to interfere with the elastic member 4, and its end facing the biased member 1 may also be arranged to be at a preset distance S from the biased member 1. In the above optional situations, the stop member 5 can be made of a metal material, and the metal material may be the same as or different from the metal material used in the connection member 3.

In practical applications, the connection member 3 can be designed and manufactured separately according to the needs. Of course, a bolt may also be used directly, and one or more nuts 6 may be installed at the end of the bolt to install the elastic member 4 and the stop member 5 on the connection member 3. The respective ends of the elastic member 4 and the stop member 5 may both abut against the nuts 6, which is exemplarily shown in FIG. 1.

It should be noted that in different applications, the elevator guiding device according to the utility model may be installed on the top, side and/or bottom of the elevator car. For example, the biased member 1 in the elevator guiding device 100 may be directly installed on the top (for example, it is installed to the crosshead or other parts at the top), side (for example, it is installed to a side frame, etc.) and/or bottom (for example, it is installed to a bottom frame, etc.) of the elevator car 200; alternatively, the elevator guiding device 100 may also be provided with a bracket for installation on the top, side and/or bottom of the elevator car 200, and the biased member 1 is installed to the bracket.

It should be noted that the utility model was described exemplarily only through the embodiment of the elevator guiding device in FIG. 1, in which the contact and force between the guiding and contacting member 2 and the elevator guiding rail 300 are realized through a combination of the roller and the pivoting arm, and the biased member 1 is pivoted to be biased away from its original position. However, it should be understood that the utility model is not limited to the specific examples described herein, and it can take other more structural forms. For example, the biased member 1 and the guiding and contacting member 2 may respectively take various feasible forms such as a slider and a friction plate fixed to the slider.

In view of the fact that the elevator guiding device according to the utility model has the above-mentioned technical advantages which are obviously superior to the prior art, it is very suitable to be applied to an elevator system so as to overcome the drawbacks and shortcomings existing in the prior art including those described above.

In another technical solution according to the utility model, an elevator system is provided, in which one or more elevator guiding devices designed and provided according to the utility model may be equipped. For example, they can be arranged at any suitable position such as the top, side and/or bottom of the elevator car in the elevator system, so that when the elevator car is running in an unbalanced loaded state along the elevator guiding rail, the elevator guiding device can be used to timely and reliably take corresponding measures to prevent the elevator car from swaying, turning over, etc., so as to effectively improve the comfort and safety of taking the elevator.

The elevator guiding device and the elevator system comprising the elevator guiding device according to the utility model have been elaborated above in detail by way of example only. These examples are merely used to illustrate the principles and embodiments of the utility model, rather than limiting the utility model. Various modifications and improvements can be made by those skilled in the art without departing from the spirit and scope of the utility model. Therefore, all equivalent technical solutions should fall within the scope of the utility model and be defined by the claims of the utility model.

What is claimed is:

1. An elevator guiding device, configured to be installed on an elevator car and comprising:
a biased member; and
a guiding and contacting member connected to the biased member and arranged to contact an elevator guiding rail when the elevator car is running in an unbalanced loaded state along the elevator guiding rail and cause the biased member to be biased, for guiding a running trajectory of the elevator car;
wherein the elevator guiding device further comprises a connection member connected to the biased member and having an elastic member and a stop member, the elastic member is arranged to provide a pre-tightening force between the biased member and the connection member and provide a resistance force when the biased member is biased, and the stop member is arranged to stop the biased member when the biased member is biased to a preset position.

2. The elevator guiding device according to claim 1, wherein the elastic member and the stop member are a spring and an annular sleeve sleeved over the connection member respectively, and the end of the annular sleeve facing the biasing part is spaced apart from the biased member by a preset distance.

3. The elevator guiding device according to claim 2, wherein the spring is a coil spring, and an outer diameter of the annular sleeve is smaller than an inner diameter of the coil spring.

4. The elevator guiding device according to claim 1, wherein the stop member is a protrusion provided along a circumferential direction on at least a part of an outer surface of the connection member, and the protrusion is configured not to interfere with the elastic member and the end of the protrusion facing the biased member is spaced apart from the biased member by a preset distance.

5. The elevator guiding device according to claim 1, wherein the connection member is a bolt with a nut installed at an end, and the respective ends of the elastic member and the stop member facing the nut both abut against the nut.

6. The elevator guiding device according to claim 1, wherein the biased member is installed on the top, side and/or bottom of the elevator car.

7. The elevator guiding device according to claim 1, further comprising a bracket installed on the top, side and/or bottom of the elevator car, and wherein the biased member is installed on the bracket.

8. The elevator guiding device according to claim 1, wherein the connection member and the elastic member are made of a metal material, and the stop member is made of an elastic material.

9. The elevator guiding device according to claim 1, wherein the biased member has a first end, and a second end fixed relative to the elevator car, the guiding and contacting member is a roller rotatably installed on the biased member and located between the first end and the second end, the biased member is arranged to be pivotable around a fixed point of the second end on the elevator car after the roller contacts the elevator guiding rail, and the connection member is installed at the first end of the biased member.

10. An elevator system, comprising:
an elevator guiding rail;
an elevator car running along the elevator guiding rail; and
one or more elevator guiding devices according to claim 1, which are installed on the elevator car.
